(19) United States
(12) Patent Application Publication
(10) Pub. No.: US 2011/0061408 A1
(43) Pub. Date: Mar. 17, 2011

(54) DEHUMIDIFIERS FOR HIGH TEMPERATURE OPERATION, AND ASSOCIATED SYSTEMS AND METHODS

(76) Inventor: Tom Schnelle, Anacortes, WA (US)

(21) Appl. No.: 12/558,389

(22) Filed: Sep. 11, 2009

(51) Int. Cl. F24F 11/00; F24F 3/14; F25B 49/02; B23P 11/00

(52) U.S. Cl. 62/93; 62/228.1; 62/230; 62/231; 62/283; 29/888.02; 29/428

(57) ABSTRACT

Dehumidifiers for high temperature operation and associated systems and methods are disclosed. A method in accordance with a particular embodiment includes drawing air into a dehumidifier and automatically monitoring an electric current drawn by a refrigerant compressor of the dehumidifier. The method can further include automatically stopping the compressor in response to the current meeting or exceeding a predetermined threshold value, and automatically restarting the compressor in response to the compressor meeting a predetermined condition that includes or corresponds to a target pressure difference between refrigerant pressures upstream and downstream of the compressor. The predetermined condition, in at least some embodiments, includes the passage of a period of time sufficient to allow refrigerant pressures upstream and downstream of the compressor to come within a preselected range of each other.

### TECHNICAL FIELD

The present disclosure is directed generally to dehumidifiers for high temperature operation, and associated systems and methods.

### BACKGROUND

Dehumidifiers are used in many different applications for removing moisture from air. For example, dehumidifiers are used in residential applications to reduce the level of humidity in the air for health reasons. Dehumidifiers are also frequently used in commercial or industrial applications to remove moisture from the air in restoration projects necessitated by flooding or other types of water damage.

A conventional dehumidifier typically includes a refrigeration cycle in which a compressor delivers a hot compressed gas refrigerant to a condenser. The condenser condenses the hot gas refrigerant to a hot liquid refrigerant and delivers the hot liquid refrigerant to an expansion device. The expansion device expands the hot liquid refrigerant to reduce the temperature and pressure of the liquid. The expansion device delivers the cooled liquid refrigerant to an evaporator, and the evaporator evaporates the cooled gas refrigerant. The evaporator returns the refrigerant to the compressor to complete the refrigeration cycle. A conventional dehumidifier typically directs airflow over some of these components of the refrigeration cycle to remove the moisture from the air. More specifically, a conventional dehumidifier typically includes an air mover that directs the airflow across the evaporator to cool the airflow below the dew point temperature of the air so that water vapor in the air is condensed to liquid and removed from the air. The air mover can also direct the dehumidified airflow across the condenser to warm the air before the airflow exits the dehumidifier.

One drawback associated with at least some existing dehumidifiers is that they do not operate as reliably or efficiently at high temperature conditions as they do at standard conditions. In particular, high temperature ambient conditions can place a higher than normal load on the compressor described above. Most existing dehumidifier compressors are provided by the manufacturer with a thermally-triggered overload sensor (e.g., a bimetallic switch) for safety reasons. The switch automatically opens to shut the compressor down at high current draw conditions. After the switch has cooled down, it closes, thus restarting the compressor. One drawback with this approach is that the refrigerant pressures upstream and downstream of the compressor may not equalize when the compressor automatically restarts. This can result in a “hard start,” which can cause the compressor to quickly overload, thus re-opening the overload switch.

Another existing approach for addressing high temperature operation of a dehumidifier is to bypass some of the incoming air around one or more elements of the dehumidifier. For example, some dehumidifiers include a manually operated bypass plate that is held in place with magnets and that can be manually moved from one position to another to bypass air around the evaporator. This arrangement is inefficient because it is not implemented automatically and because bypassing some of the inlet air reduces the effective water removal rate of the dehumidifier. Accordingly, there remains a need for dehumidifiers that can operate efficiently and effectively at high temperature conditions.

### BRIEF DESCRIPTION OF THE DRAWINGS

FIG. 1 is a partially schematic, isometric illustration of a dehumidifier having features that allow for high temperature operation in accordance with an embodiment of the disclosure.

FIG. 2 is a partially schematic, isometric illustration of an embodiment of the dehumidifier shown in FIG. 1, with portions of an external housing removed to show internal features of the dehumidifier.

FIG. 3 is a partially schematic, isometric illustration of an embodiment of the dehumidifier shown in FIGS. 1 and 2, with additional components removed for purposes of illustration.

FIG. 4 is a schematic block diagram illustrating refrigerant and airflow paths for a dehumidifier in accordance with an embodiment of the disclosure.

FIG. 5 is a schematic illustration of a controller having elements configured in accordance with an embodiment of the disclosure.

FIG. 6 is a block diagram illustrating a process for controlling a dehumidifier in accordance with an embodiment of the disclosure.

FIG. 7 is a block diagram illustrating a process for manufacturing a dehumidifier in accordance with an embodiment of the disclosure.

### DETAILED DESCRIPTION

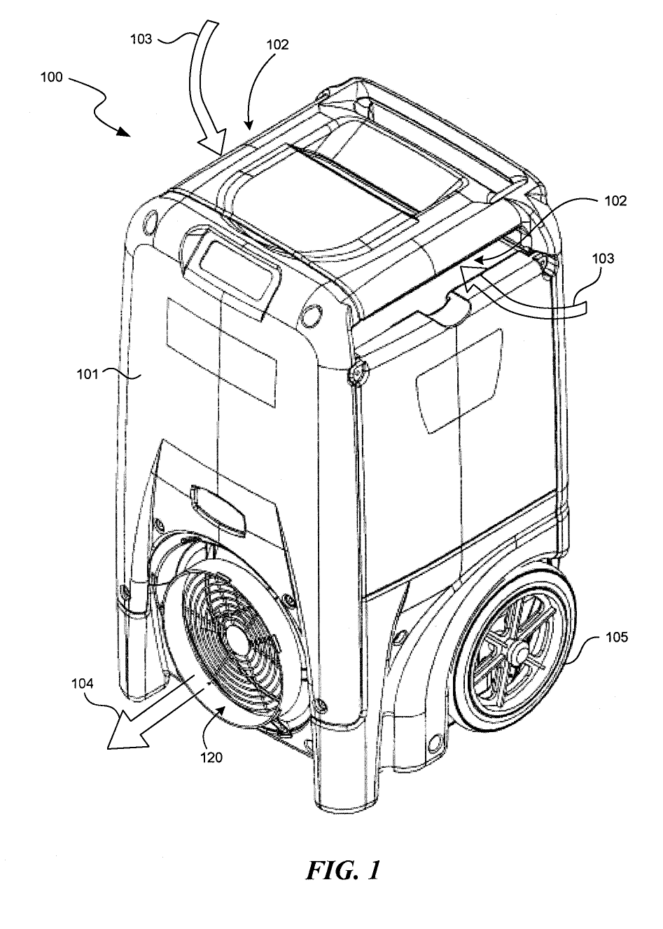

Several embodiments of the disclosure are described below with reference to dehumidifiers that are configured to remove moisture from an ambient environment at high temperature conditions. Certain details are set forth in the following description and in FIGS. 1-7 to provide a thorough understanding of various embodiments of the disclosure. Other details describing well-known structures, components, and/or processes often associated with dehumidifiers, but that may unnecessarily obscure some of the significant aspects of the present disclosure, are not set forth in the following description for purposes of clarity. In addition, although the following disclosure sets forth several embodiments of different aspects of the invention, several other embodiments can have different configurations, different components, and/or different processes than those described in this section. As such, the disclosure may include other embodiments with additional elements, and/or other embodiments without several of the elements described below with reference to FIGS. 1-7.

FIG. 1 is a partially schematic, isometric illustration of a dehumidifier 100 configured to operate at high temperature conditions in accordance with an embodiment of the disclosure. The illustrated dehumidifier 100 has two wheels 105 (one of which is visible in FIG. 1) to allow the dehumidifier 100 to be moved from one location to another. In other embodiments, certain aspects of the dehumidifier 100 described below may be applied as well to stationary dehumidifiers. The dehumidifier 100 includes a housing 101 having one or more air inlets 102 (two are shown in FIG. 1) through which ambient air 103 is drawn into the dehumidifier 100. The dehumidifier 100 cools and dries the ambient air 103 and returns expelled air 104 to the ambient environment via an air mover 120. The air mover 120 can include a fan, blower, or other suitable device capable of moving the desired volumetric flow rate of air through the dehumidifier.

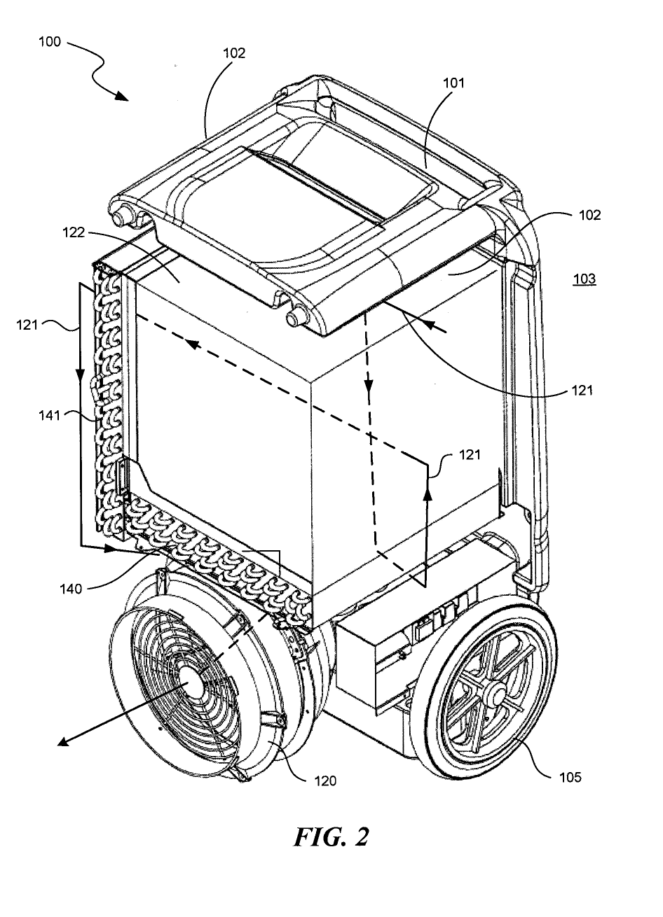

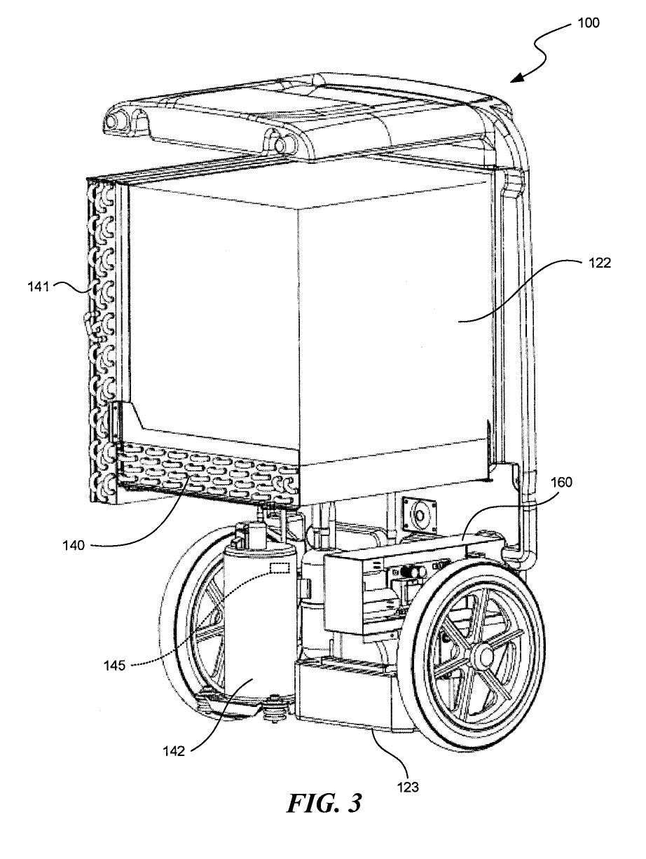

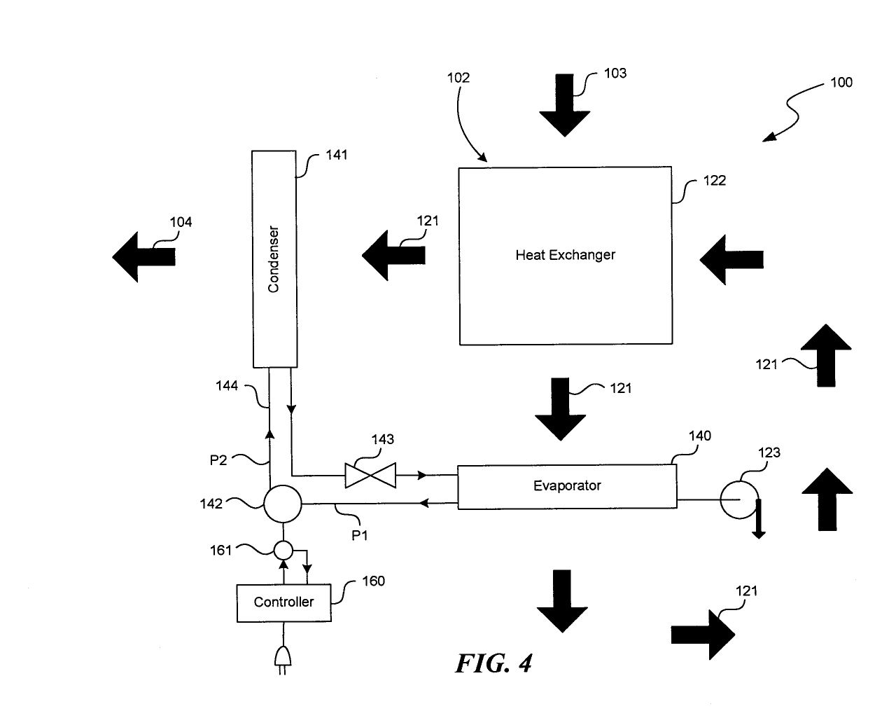

FIG. 2 is a partially schematic, isometric illustration of an embodiment of the dehumidifier 100 shown in FIG. 1 in which a portion of the housing 101 has been removed to illustrate selected internal components. These components can include a heat exchanger 122, an evaporator 140, and a condenser 141. In a particular embodiment, the ambient air 103 is drawn through the inlets 102 and pulled along an air flow path 121 by the air mover 120. The air flow path 121 includes a first pass through the heat exchanger 122 along which incoming warm, humid air can be cooled to produce cold, wet air. The air then passes through the evaporator 140 where moisture is removed from the air. The air can then make a second pass through the heat exchanger 122, which warms the air on the second pass and cools the incoming air making its first pass through the heat exchanger 122. Cool dry air exiting the heat exchanger 122 passes through the condenser 141 where it is warmed and then expelled by the air mover 120. A refrigerant is cycled between the evaporator 140 and the condenser 141 to cool and withdraw moisture from the ambient air, as described further below with reference to FIGS. 3 and 4.

FIG. 3 illustrates an embodiment of the dehumidifier 100 with the air mover 120 (FIG. 2) removed to further illustrate internal components of the dehumidifier 100. These components can include a compressor 142 that drives the refrigerant along a refrigerant path or circuit between the evaporator 140 and the condenser 141. The compressor 142 includes a thermally-activated overload switch 145 (shown schematically), which interrupts power to the compressor 142 when the current drawn by the compressor 142 exceeds predetermined compressor limits. The overload switch 145 can include a bimetallic switch that is provided along with the compressor 142 by the compressor manufacturer. The switch 145 opens at high current draw conditions, and closes when the temperature of the switch 145 falls. The switch 145 can be internal to the compressor 142 or external to the compressor 142 but connected to the electrical power supply line for the compressor 142. The switch can respond to high temperatures caused by high current draw, and/or other factors, for example, high temperatures in the environment around the compressor, and/or overheated compressor windings, neither of which may necessarily correspond to a high current draw.

As is also shown in FIG. 3, the compressor can include a pump 123 that re-directs water removed from the air at the evaporator 140. For example, the pump 123 can be connected to a hose or other outlet device. Certain aspects of the operation of the components shown in FIGS. 1-3 are controlled autonomously by a controller 160, as described further below with reference to FIGS. 4-6.

FIG. 4 is a schematic block diagram of the dehumidifier 100, illustrating a representative air path and refrigerant path, along with associated components, in accordance with a particular embodiment. The air flow path 121 is identified by heavy arrows in FIG. 4 and indicates ambient air 103 passing through the inlet 102 to the heat exchanger 122 and then through the evaporator 140 to cool the incoming air and extract moisture from the incoming air. The air then passes back through the heat exchanger 122 and through the condenser 141 before the expelled air 104 is directed back into the ambient environment. The refrigerant passes along a refrigerant path 144 indicated by small arrows in FIG. 4. The compressor 142 drives hot, gaseous refrigerant from the evaporator 140 to the condenser 141 where the refrigerant is condensed by the passing air stream. Accordingly, the incoming refrigerant pressure P1 upstream of the compressor 142 is lower than the outgoing refrigerant pressure P2 downstream of the compressor 142 during operation. The condensed refrigerant is expanded through an expansion device 143 to produce a cold, liquid refrigerant, which is directed to the evaporator 140. In the evaporator 140, the cold liquid refrigerant receives heat from the passing air, which cools and dehumidifies the air and heats and vaporizes the refrigerant.

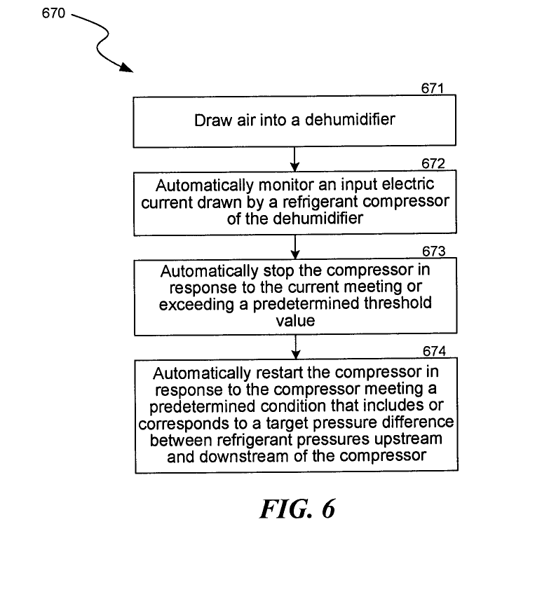

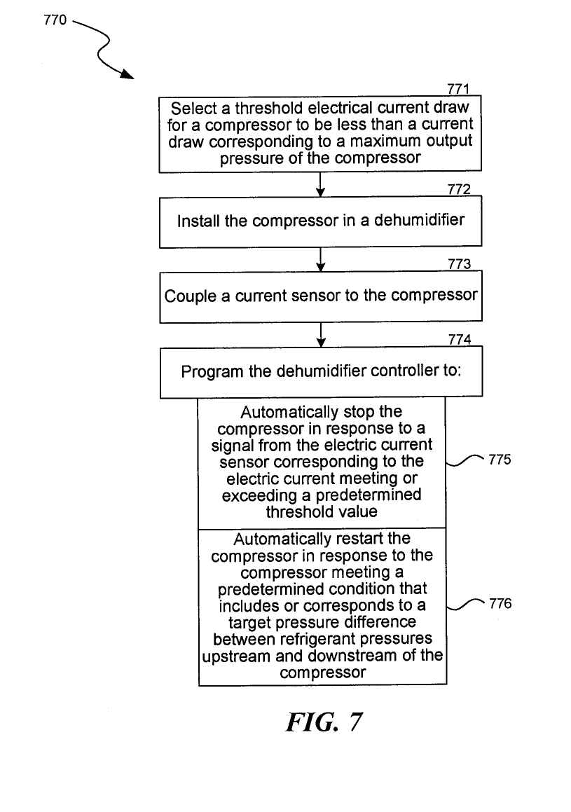

The controller 160 controls the operation of many of the components shown in FIG. 4, and can respond autonomously to signals received from one or more sensors 161. In a particular embodiment, a sensor 161 includes an electric current sensor coupled to the compressor 142 to provide an indication of the electric current drawn by the compressor 142. The sensor 161 can be provided in addition to the overload switch 145 described above and can be particularly suited to supporting high temperature operation of the dehumidifier 100. In a particular embodiment, the sensor 161 includes a solid-state, digital device, e.g., a digital ammeter. As will be described later with reference to FIGS. 6 and 7, the current drawn by the compressor 142 can be used by the controller 160 to control the operation of the compressor without triggering the overload switch 145 and/or other safety overload devices.

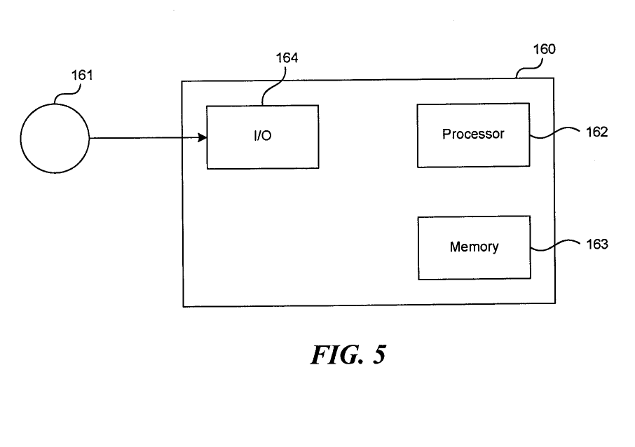

FIG. 5 is a partially schematic illustration of the controller 160 configured in accordance with an embodiment of the disclosure. The controller 160 can include an input/output facility 164 that receives inputs (e.g., analog or digital signals) from the sensor 161 and automatically directs output signals for starting and/or stopping components of the dehumidifier 100 (FIG. 4). The controller 160 can further include a processor 162 and a memory 163 that can be programmed with instructions for operating the dehumidifier 100 based on inputs received from one or more sensors 161. Accordingly, the controller 160 can operate as a special-purpose computer or data processor that is specifically programmed, configured and/or constructed to perform one or more of the computer-executable instructions described below. The instructions may reside on or in one or more computer-readable media, including the processor 162 and/or the memory 163.

FIG. 6 is a block diagram illustrating a process 670 for using a dehumidifier in a high temperature environment, in accordance with an embodiment of the disclosure. Process portion 671 includes drawing air into a dehumidifier, and process portion 672 includes automatically monitoring an input electric current drawn by a refrigerant compressor of the dehumidifier. For example, process portion 672 can include using a solid state, digital current detector to identify the current drawn by the compressor alone. In another embodiment, process portion 672 can include monitoring the combined current drawn by the compressor and other components of the dehumidifier. The current drawn by the other components of the dehumidifier can be measured separately and/or can be stored in memory and subtracted from the total current to yield the current drawn by the compressor alone. In any of these embodiments, the current drawn by the compressor can be monitored on a continuous or essentially continuous basis, or at a frequency sufficient to detect high current draws before they result in triggering an overload device (e.g., the overload switch 145 identified in FIG. 3) of the compressor.

In process portion 673, the compressor is automatically stopped in response to (e.g., in response to only) the current identified in block 672 meeting or exceeding a predetermined threshold value. Accordingly, process portion 673 can include comparing the compressor current to the predetermined threshold value. For example, in a particular embodiment, the predetermined threshold value can be about 10.5 amps. In other embodiments, the threshold value can be different, depending on factors that include the size and normal current draw of the compressor. In a particular aspect of these embodiments, the threshold value can be set to be below a current that, when drawn by the compressor, would trigger an overload shutdown of the compressor (e.g., by the overload switch 145). While the compressor is shut down, it (and/or other components of the dehumidifier) can be actively cooled. For example, the air mover 120 can remain in operation to draw air over these components.

In process portion 674, the compressor is automatically restarted in response to (e.g., in response to only) the compressor meeting a predetermined condition that includes or corresponds to the target pressure difference between refrigerant pressures upstream and downstream of the compressor. For example, in one embodiment, the predetermined condition can include the passage of a period of time selected to allow the refrigerant pressures upstream and downstream of the compressor to equalize or approximately equalize. In a particular embodiment, this time period can be about ten minutes so as to allow the difference in refrigerant pressures upstream and downstream of the compressor to decrease to a value of about 4 psi or less. In other embodiments, the predetermined condition can be based on other parameter values. For example, the predetermined condition can be an actual difference between the upstream and downstream pressures, rather than a time interval estimated to allow that pressure difference to occur. In this example, the sensor 161 (FIG. 4) can include one or more pressure sensors positioned in fluid communication with the refrigerant path 144, and associated hardware and/or software to determine the difference between upstream and downstream pressures P1, P2 (FIG. 4). In another example, the sensor 161 can include a temperature sensor positioned to detect a temperature of the compressor and/or another parameter correlated with a state of the compressor that is associated with a normal start rather than a hard start. For example, the predetermined condition can be the temperature corresponding to a condition at which the refrigerant pressures upstream and downstream of the compressor are within an acceptable range of each other. In still further embodiments, correlates other than time, temperature and/or pressure can be used to identify the predetermined condition on which restarting the compressor is based.

In any of the foregoing embodiments, the value of the predetermined condition can be determined experimentally for a particular compressor/dehumidifier prototype combination, and then programmed into the controller of production units. In any of the foregoing embodiments, the value of the predetermined condition can be selected to avoid automatically restarting the compressor when the pressures upstream and downstream of the compressor are different enough to cause a “hard start.” As used herein, the term hard start is used to mean a compressor start that results in a higher than normal current draw due to the difference in refrigerant pressures upstream and downstream of the compressor, and/or that produces higher than normal starting loads on the compressor components. For example, representative current draws are those that are sufficient or nearly sufficient to shut the compressor down via the controller 160, the overload switch 145, or a circuit breaker (or similar device) connected between an electric power source and the controller 160. In other embodiments, hard starts can produce lesser current draws, but are nonetheless undesirable because they can damage compressor components and/or cause premature compressor wear, particularly if they occur relatively frequently. Hard starts can also put an undesirable load on the power source (e.g., household circuitry), and can adversely affect other components in the drying area.

As described above, the value of the predetermined condition (e.g., the elapsed time interval before re-starting the compressor) can correspond to a refrigerant pressure difference across the compressor of 4 psi or less in a particular embodiment. In other embodiments, the pressure difference can have other values, for example, values of less than 15 psi. The particular value selected for the predetermined condition can be based upon the particularities of a given compressor design, and can be determined experimentally. For example, a dehumidifier manufacturer can experimentally determine the minimum pressure differential across the compressor that will trigger a hard start, and then determine the minimum period of elapsed time after a compressor shutdown that is required to allow the actual pressure differential to fall below the minimum pressure differential.

FIG. 7 is a schematic block diagram illustrating a process 770 for manufacturing a dehumidifier in accordance with an embodiment of the disclosure. Process portion 771 includes selecting a threshold electrical current draw for a compressor to be less than the current draw corresponding to a maximum output pressure of the compressor. Accordingly, the threshold electrical current draw selected for the compressor will be reached before the maximum output pressure of the compressor is reached. In a representative embodiment, the maximum output pressure of the compressor is about 617 psi, and the threshold electrical current is selected to correspond to an output pressure of about 600 psi. In particular embodiments, the threshold electrical current draw is selected to be less than a current draw at which a preset thermally activated overload detector of the compressor (e.g., the overload switch 145) detects an overload condition. Accordingly, the threshold electrical current draw selected for the compressor will be reached before the thermally-activated overload detector is tripped.

In process portion 772, the compressor is installed in a dehumidifier, and in process portion 773, a current sensor is coupled to the compressor. The current sensor is provided in addition to the preset thermally triggered overload detector of the compressor, although both may sense the current drawn by the compressor.

In process portion 774, the dehumidifier controller is programmed with instructions for automatically controlling the compressor. The instructions can include instructions for automatically stopping the compressor in response to a signal from the electric current sensor corresponding to the electric current meeting or exceeding the predetermined threshold value (process portion 775). The controller is further programmed with instructions for automatically restarting the compressor in response to the compressor meeting a predetermined condition that includes or corresponds to the target pressure difference between refrigerant pressures upstream and downstream of the compressor (process portion 776). The threshold values and predetermined conditions can include those discussed above with reference to FIG. 6.

The particular value selected for the predetermined condition can depend on the particular dehumidifier in which the compressor is installed. For example, the fluid mechanical characteristics of the refrigerant circuit will typically depend upon the characteristics of the condenser, evaporator, expansion device and/or heat exchanger. Accordingly, the time interval corresponding to an upstream/downstream pressure differential that does not trigger a hard start may differ from one model of dehumidifier to the next. By having this value coded in computer-executed instructions, it can be easily selected and/or changed in a manner that depends upon the model or type of dehumidifier in which the compressor is installed. This is unlike the thermally-activated overload switch, which is typically not adjustable.

One feature of several of the embodiments described above is that the dehumidifier can include a controller that automatically stops the compressor when the current drawn by the compressor meets or exceeds a predetermined value, and automatically restarts the compressor in response to the compressor meeting a predetermined condition that includes or corresponds to the refrigerant pressure differential across the compressor. This feature is unlike existing thermally triggered overload devices typically built into compressors. In particular, such existing devices typically include a bimetallic safety switch that opens when the temperature of the switch is too high, and closes when the switch cools down. However, the temperature of the switch may not correspond well to certain operating parameters of the compressor. In particular, such switches may close and restart the compressor while the pressure difference across the compressor is sufficient to trigger a hard start. The hard start may create unnecessary wear on the compressor and/or may trip a circuit breaker in the house, business, or other structure from which the dehumidifier draws power.

At the same time, the operation of the current monitor can be automated in a manner that avoids interference with the existing thermally-triggered overload detector. For example, the thermally-triggered overload detector can still detect high environmental temperatures and/or high temperatures due to the compressor windings overheating, independent of compressor current draw. In the unlikely event that the compressor experiences a hard start, the thermally-triggered overload detector will shut the compressor down in a relatively short period of time (e.g., 1-2 seconds). The current detector provided for high temperature operation, by contrast, can be programmed to shut the compressor down only after a longer delay, e.g., about 5 seconds, during which the system can record multiple consecutive readings from the current detector. This arrangement allows the thermally-triggered overload sensor to function as intended, and prevents the current detector from immediately responding to a transient positive signal and unnecessarily triggering a restart sequence. The present current monitor can also be automated in a manner that avoids interference with the operation of existing restart delays associated with manual shutdowns. For example, many existing dehumidifiers include a 60-second delay feature, which delays restarting the dehumidifier for 60 seconds after a manual stop, and which is suitable for normal operating conditions. The presently disclosed system, which allows a longer delay after stops that are triggered by high temperature operation, (e.g., those which draw high current), will not interfere with the delay triggered by manually stopping and restarting the dehumidifier.

An expected advantage of the foregoing features is that the compressor will be capable of operating in high temperature, high humidity conditions without shutting down unnecessarily. A representative high temperature condition includes a temperature of up to 125° F. and a relative humidity of up to about 32%. At these conditions, a compressor in accordance with particular embodiments of the disclosure is capable of operating indefinitely, e.g., for multiple hours continuously. When conditions exceed the foregoing temperature and/or humidity limits by a suitable margin, the solid state monitor and controller can reliably shut down the compressor and restart the compressor once the predetermined restart condition is met. In a particular embodiment, the margin can be about 5° F. Accordingly, the dehumidifier can operate at up to about 130° F. without automatically shutting down. In other embodiments, the margin can be set to another value that results in temperatures or pressures associated with the compressor that are below (e.g., just below) those which trigger an automatic overload reset. The solid state nature of these devices allows the devices to conduct the shutdown and restart operations repeatedly (if necessary) without wear and tear. This is unlike the operation of a typical bimetallic safety switch, which is typically not designed for multiple, repeated activations.

Still another expected advantage of at least some of the foregoing features is that the operation of shutting down the compressor and restarting the compressor can be fully automated, thus allowing the dehumidifier to be used in high temperature conditions without the need for manual intervention by the operator. In particular, this arrangement is unlike some existing devices that include a manually movable bypass door or other bypass features. Such devices require the operator to manually position the door to allow incoming air to bypass elements of the dehumidifier in an effort to reduce dehumidifier load during high temperature operation. The operator must then manually reset the door when the dehumidifier is not used in a high temperature environment in order to obtain expected operational efficiency levels.

Yet another feature of at least some of the foregoing embodiments is that aspects of the automated method for shutting down and restarting the compressor can take advantage of existing capabilities of the controller. For example, the controller can include instructions for controlling a defrost cycle of the dehumidifier, a total number of hours during which the dehumidifier operates, and/or the display of temperatures at the dehumidifier entrance and exit. At least some of these operations rely on an internal clock function. This clock function can also provide the basis (e.g., the input) for the delay period between shutting down the compressor and restarting the compressor, as described above.

From the foregoing, it will be appreciated that specific embodiments of the disclosure have been described herein for purposes of illustration, but that various modifications may be made without deviating from the present disclosure. For example, the threshold values described above can have different numerical values depending upon the particular compressor and/or dehumidifier in which the compressor is installed. Certain aspects of the disclosure described in the context of particular embodiments may be combined or eliminated in other embodiments. For example, the foregoing current monitoring system and method can be applied to dehumidifiers that do not include a heat exchanger. Further, while advantages associated with certain embodiments have been described in the context of those embodiments, other embodiments may also exhibit such advantages. Not all embodiments need necessarily exhibit such advantages to fall within the scope of the present disclosure. Accordingly, the present disclosure can include other embodiments not expressly shown or described above.

I/We claim:

1. A method for operating a dehumidifier, comprising:
drawing air into a dehumidifier;
automatically monitoring an electric current drawn by a refrigerant compressor of the dehumidifier;
automatically stopping the compressor in response to the current meeting or exceeding a predetermined threshold value; and
automatically restarting the compressor in response to the compressor meeting a predetermined condition that includes or corresponds to a target pressure difference between refrigerant pressures upstream and downstream of the compressor.

2. The method of claim 1, wherein:
drawing air into the dehumidifier includes drawing air at a temperature of 125° F. and a relative humidity of 32% from within a building continuously for multiple hours without automatically stopping the compressor and without manually changing an airflow configuration of the dehumidifier to accommodate operation at temperatures above standard room temperature;
automatically stopping the compressor includes automatically stopping the compressor while continuing to move air through the dehumidifier with a blower; and
automatically restarting the compressor includes automatically restarting the compressor only after a predetermined period of time has elapsed, with the predetermined period of time selected to allow the refrigerant pressures upstream and downstream of the compressor to be within 4 psi of each other.

3. The method of claim 1, wherein the predetermined condition includes a predetermined elapsed period of time after the compressor is stopped.

4. The method of claim 3 wherein the elapsed period of time is about ten minutes.

5. The method of claim 1, further comprising determining a difference between refrigerant pressures upstream and downstream of the compressor, and wherein the predetermined condition includes a target pressure value for the difference between refrigerant pressures upstream and downstream of the compressor.

6. The method of claim 1 wherein the predetermined condition includes a temperature of the compressor.

7. The method of claim 1 wherein drawing air into the dehumidifier includes drawing air at a temperature of 125° F. and a relative humidity of 32% continuously for multiple hours without automatically stopping the compressor.

8. The method of claim 1 wherein drawing air into the dehumidifier includes drawing air at a temperature of 130° F. without automatically stopping the compressor.

9. The method of claim 1 wherein automatically stopping the compressor includes automatically stopping the compressor when the current meets or exceeds a value of 10.5 amps.

10. The method of claim 1 wherein monitoring an electric current includes monitoring an electric current drawn by only the compressor.

11. The method of claim 1 wherein monitoring an electric current includes monitoring an electric current drawn by the compressor and at least one other component of the dehumidifier.

12. The method of claim 1 wherein the threshold value is a first threshold value, and wherein monitoring the electric current includes monitoring the electric current with a solid state device, and wherein the method further comprises automatically stopping the compressor with a thermally-activated overload switch when the current drawn by the compressor meets or exceeds a second threshold value greater than the first threshold value.

13. The method of claim 1 wherein automatically stopping the compressor includes delaying stopping the compressor until after multiple indications of the current meeting or exceeding the predetermined threshold value are received.

14. The method of claim 1 wherein automatically stopping the compressor includes automatically stopping the compressor only in response to multiple consecutive indications that the current meets or exceeds the predetermined threshold value.

15. A dehumidifier, comprising:
a housing enclosing at least in part an airflow path having an entrance and an exit;
an airmover positioned along the airflow path to move air through the housing;
a refrigeration cycle that includes:
an evaporator positioned along the airflow path to remove moisture from air in the airflow path;
a condenser positioned along the airflow path and coupled to the evaporator to receive gaseous refrigerant from the evaporator and provide liquid refrigerant to the evaporator; and
a compressor coupled between the evaporator and the condenser to drive the refrigerant;
an electric current sensor operatively coupled to the compressor to detect an electric current drawn by the compressor; and
a controller operatively coupled to the compressor and the current sensor, the controller including a computer-readable medium programmed with instructions that, when executed:
automatically stop the compressor in response to a signal from the electric current sensor corresponding to the electric current meeting or exceeding a predetermined threshold current value; and
automatically restart the compressor in response to the compressor meeting a predetermined condition that includes or corresponds to a target refrigerant pressure difference upstream and downstream of the compressor.

16. The dehumidifier of claim 15 wherein the threshold value is a first threshold value, and the electric current sensor is a solid state device, and wherein the dehumidifier further comprises a thermally-activated overload switch operatively coupled to the compressor to automatically stop the compressor when the current drawn by the compressor meets or exceeds a second threshold value greater than the first threshold value.

17. The dehumidifier of claim 15 wherein the computer-readable medium is programmed with further instructions that, when executed:
control a defrost cycle of the dehumidifier;
track a total number of hours during which the dehumidifier operates; and
direct a display of temperatures at the dehumidifier entrance and exit.

18. The dehumidifier of claim 15, further comprising a thermally-activated overload switch connected to the compressor, and wherein the instruction for automatically stopping the compressor includes delaying stopping the compressor until after multiple indications of the current meeting or exceeding the predetermined threshold value are received.

19. The dehumidifier of claim 15 wherein the instruction for automatically stopping the compressor includes automatically stopping the compressor only in response to multiple consecutive indications that the current meets or exceeds the predetermined threshold value.

20. A method for manufacturing a dehumidifier, comprising:
selecting a threshold electrical current draw for a refrigerant compressor to be less than a current draw corresponding to a maximum output pressure of the compressor;
installing the compressor in a dehumidifier;
coupling a current sensor to the compressor; and
programming a controller of the dehumidifier with instructions that, when executed:
automatically stop the compressor in response to a signal from the electric current sensor corresponding to the electric current meeting or exceeding the threshold electrical current draw; and
automatically restart the compressor in response the compressor meeting a predetermined condition that includes or corresponds to a target pressure difference between refrigerant pressures upstream and downstream of the compressor.

21. The method of claim 20, further comprising selecting the threshold electrical current draw to be less than a current draw for which a thermally-activated overload switch of the compressor opens.

22. The method of claim 20 wherein selecting the threshold electrical current draw includes selecting the threshold current draw based at least in part on characteristics of other components of the dehumidifier that receive refrigerant from the compressor.

23. The method of claim 20 wherein the predetermined condition includes an elapsed period of time after the compressor is stopped.

24. The method of claim 23 wherein the elapsed period of time is about ten minutes.

25. The method of claim 23, further comprising basing the elapsed period of time at least in part on an expected time period during which the target pressure difference will fall to or below a preselected value.

26. The method of claim 20 wherein the predetermined condition includes the difference between refrigerant pressures upstream and downstream of the compressor being at or below a preselected value.

27. The method of claim 20 wherein the predetermined condition includes a temperature of the compressor.
